(19) United States
(12) Patent Application Publication
(10) Pub. No.: US 2011/0125781 A1
(43) Pub. Date: May 26, 2011

(54) IMAGE PROCESSING APPARATUS, IMAGE PROCESSING SYSTEM, CONTROL METHOD FOR THESE, AND STORAGE MEDIUM

(75) Inventor: Kimito Kasahara, Kawasaki-shi (JP)

(73) Assignee: CANON KABUSHIKI KAISHA, Tokyo (JP)

(21) Appl. No.: 12/941,550

(22) Filed: Nov. 8, 2010

(30) Foreign Application Priority Data
Nov. 20, 2009 (JP) 2009-265534

(51) Int. Cl. G06F 17/30

(52) U.S. Cl. 707/769; 707/E17.014

(57) ABSTRACT

Provided is an image processing apparatus and a control method for the same that alleviate the trouble entailed in a user operation when executing processes by combining a plurality of functions, and that, in the case where a process has been selected from a usage history, reliably execute the process with use of settings intended by a user. To accomplish this, if the user has been successfully authenticated, the image processing apparatus selects a process definition file that is to be executed from among previously used process definition files corresponding to identification information used in the user authentication, and obtains the selected process definition file from a management apparatus. If content of a defined process differs between the previously used process definition file and the obtained process definition file, the image processing apparatus inquires the user as to whether the obtained process definition file is to be used.

### BACKGROUND OF THE INVENTION

1. Field of the Invention

The present invention relates to an image processing apparatus, an image processing system, a control method for these, and a storage medium.

2. Description of the Related Art

In recent years, there are known to be image processing systems that include a reading function for reading an image on an original and generating image data, and a transmission function for transmitting the generated image data. In such image processing systems, a user designates reading parameters used when reading the image on the original, as well as parameters such as a transmission protocol and a transmission destination used when transmitting the generated image data. In a plurality of image processing apparatuses included in such image processing systems, the generation of image data by reading an image on an original and the transmission of the generated image data are performed in accordance with the content designated by the user.

When executing a series of processes by combining functions in this way, there is often a wide range of content that needs to be designated by the user, and thus there is the problem that the user is required to perform troublesome operations. To address this problem, Japanese Patent Laid-Open No. 2004-287860 proposes a system in which in the case of executing a plurality of functions in collaboration with each other, an instruction sheet that defines the content of a plurality of processes that are to be executed is created in advance and stored in a server that is network-connected to an image processing apparatus. Specifically, the image processing apparatus obtains the instruction sheet from the server, and processes a document in accordance with the definitions described in the instruction sheet. According to the method described in Japanese Patent Laid-Open No. 2004-287860, the user needs only instruct the execution of the instruction sheet that has been provided in advance in order for the processes in the content described in the instruction sheet to be successively executed, thus enabling alleviation of the trouble entailed in user operations. Also, Japanese Patent Laid-Open No. 2003-330638 proposes an apparatus that, in order to save the trouble of perform setting related to print function processes, stores the content of previously executed processes as a history, and re-executes a process with use of the history.

However, the following problems exist in the above-described conventional technology. As one example, with an image processing apparatus in which processes to be executed are designated by obtaining and selecting a pre-created instruction sheet from a server, a user who desires to perform an operation that is the same as a previous operation (e.g., a re-transmission function) needs to again select the instruction sheet via the server. This increases the processing load, as well as causes the user to perform a troublesome operation. In view of this, it is conceivable to provide such an image processing apparatus with an additional function for storing the content of previously executed processes as a history, and re-executing a process with use of the history.

However, with such an image processing apparatus, if the instruction sheet is modified in the server where it is stored, those modifications will not be reflected when a process is re-executed. On the other hand, if only the image processing apparatus stores information necessary for obtaining the instruction sheet, if the instruction sheet has been modified in the server where it is stored, a user who desires to use the re-transmission function will not be able to be aware of the modifications, and there is the risk that transmission will be performed using an unintended setting.

### SUMMARY OF THE INVENTION

The present invention enables realization of an image processing apparatus, an image processing system, a control method for these, and a storage medium that alleviate the trouble entailed in a user operation when executing processes by combining a plurality of functions, and, in the case where a process has been selected from a usage history, enables reliable execution of the process with use of settings intended by a user.

One aspect of the present invention provides an image processing apparatus that can be connected to another image processing apparatus and a management apparatus that manages a process definition file in an updatable manner, the process definition file defining a procedure for execution of a cooperative process provided by a plurality of image processing apparatuses, the image processing apparatus comprising: an authentication unit that performs user authentication; a display unit that, in a case where a user has been successfully authenticated, displays a selection screen in which the process definition file is displayed so as to be selectable from history information that indicates a usage history of the process definition file that is in association with identification information of the authenticated user; a selection unit that selects the process definition file in accordance with information that has been input by the user via an operation unit; an obtaining unit that obtains the selected process definition file from the management apparatus; a comparison unit that compares the obtained process definition file with the process definition file pertaining to a previous usage; and an inquiry unit that, in a case where a result of the comparison performed by the comparison unit is that content of a defined process is different between the process definition files, inquires the user as to whether the process definition file that is different from the process definition file pertaining to the previous usage is to be used.

Another aspect of the present invention provides an image processing system comprising a plurality of image processing apparatuses and a management apparatus that manages a process definition file in an updatable manner, the process definition file defining a procedure for execution of a cooperative process provided by the plurality of image processing apparatuses, each of the image processing apparatuses comprising: an authentication unit that performs user authentication; a display unit that, in a case where a user has been successfully authenticated, displays a selection screen in which the process definition file is displayed so as to be selectable from history information that indicates a usage history of the process definition file that is in association with identification information of the authenticated user; a selection unit that selects the process definition file in accordance with information that has been input by the user via an operation unit; an obtaining unit that obtains the selected process definition file from the management apparatus; a comparison unit that compares the obtained process definition file with the process definition file pertaining to a previous usage; and an inquiry unit that, in a case where a result of the comparison performed by the comparison unit is that content of a defined process is different between the process definition files, inquires the user as to whether the process definition file that is different from the process definition file pertaining to the previous usage is to be used.

Still another aspect of the present invention provides a control method for an image processing apparatus that can be connected to another image processing apparatus and a management apparatus that manages a process definition file in an updatable manner, the process definition file defining a procedure for execution of a cooperative process provided by a plurality of image processing apparatuses, the control method comprising: performing user authentication by an authentication unit; in a case where a user has been successfully authenticated, displaying, by a display unit, a selection screen in which the process definition file is displayed so as to be selectable from history information that indicates a usage history of the process definition file that is in association with identification information of the authenticated user; selecting, by a selection unit, the process definition file in accordance with information that has been input by the user via an operation unit; obtaining, by an obtaining unit, the selected process definition file from the management apparatus; comparing, by a comparison unit, the obtained process definition file with the process definition file pertaining to a previous usage; and in a case where a result of the comparison performed by the comparison unit is that content of a defined process is different between the process definition files, inquiring, by an inquiry unit, the user as to whether the process definition file that is different from the process definition file pertaining to the previous usage is to be used.

Still yet another aspect of the present invention provides a control method for an image processing system comprising a plurality of image processing apparatuses and a management apparatus that manages a process definition file in an updatable manner, the process definition file defining a procedure for execution of a cooperative process provided by the plurality of image processing apparatuses, the control method comprising: in each of the image processing apparatuses, performing user authentication by an authentication unit; in a case where a user has been successfully authenticated, displaying, by a display unit, a selection screen in which the process definition file is displayed so as to be selectable from history information that indicates a usage history of the process definition file that is in association with identification information of the authenticated user; selecting, by a selection unit, the process definition file in accordance with information that has been input by the user via an operation unit; obtaining, by an obtaining unit, the selected process definition file from the management apparatus; comparing, by a comparison unit, the obtained process definition file with the process definition file pertaining to a previous usage; and in a case where a result of the comparison performed by the comparison unit is that content of a defined process is different between the process definition files, inquiring, by an inquiry unit, the user as to whether the process definition file that is different from the process definition file pertaining to the previous usage is to be used.

Yet still another aspect of the present invention provides a computer-readable storage medium storing a computer program for causing a computer to execute the control method for the image processing apparatus.

Still yet another aspect of the present invention provides a computer-readable storage medium storing a computer program for causing a computer to execute the control method for the image processing system.

Further features of the present invention will be apparent from the following description of exemplary embodiments with reference to the attached drawings.

### BRIEF DESCRIPTION OF THE DRAWINGS

FIG. 1 is a diagram showing an example of a configuration of an image processing system 100 according to Embodiment 1.

FIG. 2 is a block diagram showing a configuration of apparatuses in the image processing system 100 according to Embodiment 1.

FIG. 3 is a diagram conceptually showing operations performed in the image processing system 100 according to Embodiment 1.

FIG. 4 is a flowchart showing an operation procedure performed by an MFP 103 in accordance with a process definition file 410 according to Embodiment 1.

FIG. 5 is a diagram showing an example of a selection screen 700 for selecting a process definition file 410 according to Embodiment 1.

FIG. 6 is a diagram showing a history management file 801 according to Embodiment 1.

FIG. 7 is a flowchart showing an operation procedure performed by the MFP 103 with use of history information according to Embodiment 1.

FIG. 8 is a diagram showing examples of a history screen 1000 and a warning screen 1100 according to Embodiment 1.

FIG. 9 is a flowchart showing an operation procedure performed by the MFP 103 in accordance with the process definition file 410 according to Embodiment 2.

FIG. 10 is a diagram showing a history management file 1301 according to Embodiment 2.

FIG. 11 is a flowchart showing an operation procedure performed by the MFP 103 with use of history information according to Embodiment 2.

FIG. 12 is a diagram showing a history management file 1501 according to Embodiment 3.

FIG. 13 is a flowchart showing an operation procedure performed by the MFP 103 with use of history information according to Embodiment 3.

FIG. 14 is a diagram showing examples of warning screens 1700, 1800, and 1900 according to Embodiment 3.

FIG. 15 is a diagram showing an example of a storage setting screen 2000 according to Embodiment 3.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### Embodiment 1

### Configuration of Image Processing System

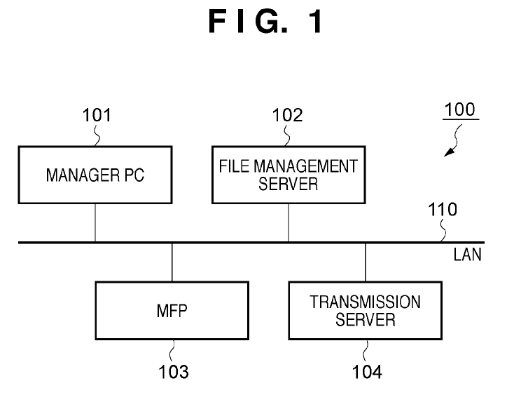

Below is a description of Embodiment 1 of the present invention. First, a description is given of the configuration of an image processing system 100 of the present embodiment with reference to FIG. 1. A manager PC 101, a file management server 102, an MFP 103, and a transmission server 104 are connected to a LAN 110 such that communication therebetween is possible. Note that although not shown in FIG. 1, an email server, an FTP server, a user PC and the like may also be connected to the LAN 110. In this case, the transmission server 104 and the user PC can exchange emails with each other, and can exchange image data with use of the FTP protocol. It should be noted that the following description takes the example of using a multi function printer (MFP) as the image processing apparatus. However, the present invention is applicable to any image processing apparatus that includes a plurality of functions, one example of which is an image processing apparatus that reads image data from an original and forms an image on a recording material such as paper in accordance with the read image data. The transmission server 104 is also employed as an image processing apparatus in the image processing system 1000 of the present embodiment. In this way, instead of being limited to only an image processing apparatus, an information processing apparatus such as a transmission server is also applicable as an image processing apparatus of the present embodiment.

The file management server 102 manages process definition files that are for executing processes through the collaboration of functions of the apparatuses in the image processing system 1000. Process content indicating which processes are to be executed by which apparatuses, procedures for such processes, setting parameters in the processes, and the like are defined in advance in a process definition file. Each process definition file is managed in association with a user ID, which is user identification information. Accordingly, if a user has logged in to the image processing system 1000 via the MFP 103, the MFP 103 can obtain a process definition file related to the user from the file management server 102 with use of the user ID. Process definition files are also registered in the file management server 102 so as to be able to be updated via the manager PC 101. Registering a process definition file managed by the file management server 102 so as to be able to be updated in this way eliminates the need to store the process definition file in each apparatus included in the image processing system 1000, and furthermore enables modifications to be performed in a collective manner.

Configuration of Apparatuses

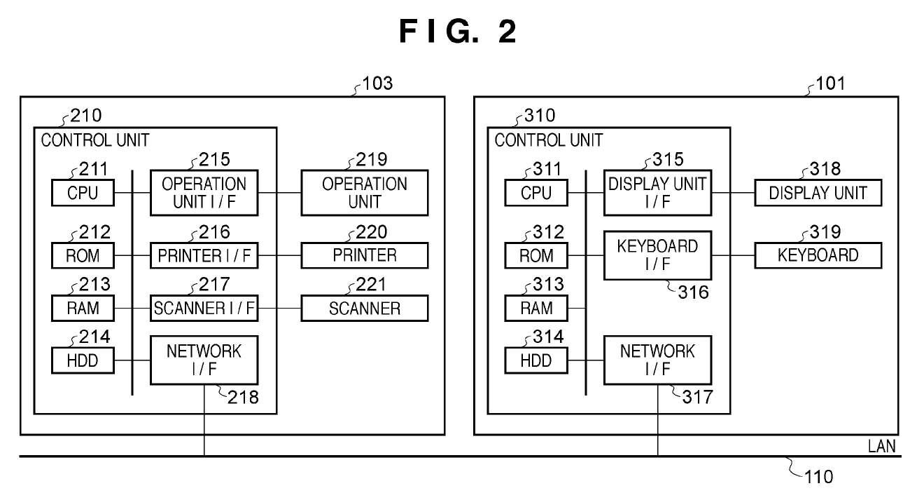

Next is a description of the configurations of the apparatuses included in the image processing system 100 with reference to FIG. 2. First, a description is given of the configurations of the manager PC 101 and the MFP 103. Note that the configurations of the file management server 102 and the transmission server 104 are similar to the configuration of the manager PC 101, and therefore descriptions thereof have been omitted.

First is a description of the configuration of the MFP 103. The MFP 103 includes a control unit 210, an operation unit 219, a printer 220, and a scanner 221. The control unit 210 includes a CPU 211, a ROM 212, a RAM 213, an HDD 214, an operation unit I/F 215, a printer I/F 216, a scanner I/F 217, and a network I/F 218. The control unit 210 including the CPU 211 controls overall operations of the MFP 103. The CPU 211 reads out a control program stored in the ROM 212, and executes various types of control processing such as reading control and transmission control. The RAM 213 is used as a temporary storage area such as a main memory and a work area for the CPU 211. The HDD 214 stores image data, various types of programs, and various types of information tables that are described later.

The operation unit I/F 215 connects the operation unit 219 and the control unit 210. The operation unit 219 is provided with a keyboard, a liquid crystal display unit having a touch panel function, and the like. The printer I/F 216 connects the printer 220 and the control unit 210. Image data to be printed by the printer 220 is transferred from the control unit 210 to the printer 220 via the printer I/F 216, and is then printed on a recording medium by the printer 220. The scanner I/F 217 connects the scanner 221 and the control unit 210. The scanner 221 generates image data by reading an image on an original, and inputs the generated image data to the control unit 210 via the scanner I/F 217. The network I/F 218 connects the control unit 210 and the LAN 110. The network I/F 218 transmits image data to an external apparatus (e.g., the transmission server 104) on the LAN 110, and receives various types of information from an external apparatus (e.g., the transmission server 104) on the LAN 110.

Next is a description of the configuration of the manager PC 101. The manager PC 101 includes a control unit 310, a display unit 318, and a keyboard 319. The control unit 310 includes a CPU 311, a ROM 312, a RAM 313, an HDD 314, a display unit I/F 315, a keyboard I/F 316, and a network I/F 317. The control unit 310 including the CPU 311 controls overall operations of the manager PC 101. The CPU 311 reads out a control program stored in the ROM 312, and executes various types of control processing. The RAM 313 is used as a temporary storage area such as a main memory and a work area for the CPU 311. The HDD 314 stores image data, various types of programs, and various types of information tables that are described later.

The display unit I/F 315 connects the display unit 318 and the control unit 310. The keyboard I/F 316 connects the keyboard 319 and the control unit 310. The CPU 311 recognizes a instruction received from the user via the keyboard 319, and changes the screen displayed by the display unit 318 in accordance with the recognized instruction. The network I/F 317 connects the control unit 310 and the LAN 110. The network I/F 317 exchanges various types of information with another apparatus on the LAN 110.

Operations of Image Processing System

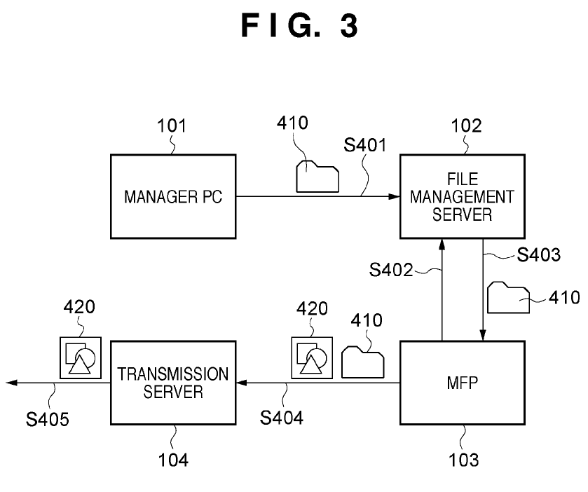

Next is a conceptual description of the overall operations of the image processing system 100 with reference to FIG. 3. Firstly, the user operates the manager PC 101 and creates a process definition file 410. Definitions for executing a series of processes with use of a plurality of functions included in the MFP 103, the transmission server 104, and the like are described in the process definition file 410. Note that it is assumed here that the series of processes defined in the process definition file 410 is for causing the MFP 103 to generate image data by reading an image on an original, and causing the generated image data to be transmitted from the transmission server 104 to a predetermined destination. The user can input various process content (e.g., a reading parameter and a transmission destination) via a process definition file creation screen displayed by the manager PC 101.

After the creation of the process definition file 410 has been completed, in S401 the manager PC 101 transmits the created process definition file 410 to the file management server 102 via the LAN 110. Here, in addition to the process definition file 410, the manager PC 101 may transmit, for example, the user ID of the user who created the process definition file 410 to the file management server 102. Upon receiving the process definition file 410, the file management server 102 registers and holds the received process definition file 410 in association with the user ID.

Thereafter, if the user has logged in to the MFP 103, in S402 the MFP 103 requests process definition files 410 corresponding to the logged-in user, by transmitting the user ID corresponding to the logged-in user to the file management server 102. Upon receiving the request for process definition files 410, in S403 the file management server 102 reads out the process definition file 410 that corresponds to the received user ID, and transmits the process definition file 410 to the MFP 103 via the LAN 110.

Upon obtaining the process definition file 410 from the file management server 102, the MFP 103 displays the obtained process definition file 410 to the user, and receives a selection of the process definition file 410 from the user. In other words, a plurality of process definition files 410 may be obtained from the file management server 102 in response to a request.

Upon the process definition file 410 being selected, in S404 the MFP 103 causes the scanner 221 to execute reading processing based on the definitions described in the selected process definition file 410, thus generating image data. Subsequently, in S405 the MFP 103 transmits image data 420, which is the generated image data, and the process definition file 410 to the transmission server 104, and requests the transmission server 104 to transmit the image data. In S406, in accordance with the definitions described in the received process definition file 410, the transmission server 104 transmits the image data 420 to the destination defined in the process definition file 410 with use of email, the FTP protocol, or the like.

The configuration described above eliminates the need for the user to perform troublesome operations such as designating a transmission destination and reading parameters each time an original is to be read by the MFP 103. Furthermore, preventing the content designated when the process definition file 410 was created by the manager PC 101 from being modified by the MFP 103 enables prevention of processing not intended by the manager from being executed by the user who is using the MFP 103.

Process Definition File

Next is a description of a specific example of content described in the process definition file 410 registered in the file management server 102. Note that although content is described in the XML format in the example shown below, the process definition file 410 may be described in another format. The processes defined in the process definition file 410 are described as XML tags, and the sequence in which the processes appear in the process definition file 410 indicates the sequence in which the processes are executed.

### Specific Example of Process Definition File

<?xml version=”1.0” encoding=”UTF-8” ?>
<Process id=”0001” caption=”Scan and email to section
chief” >...(1)

<Scan>...(2)

<Setting type=”color”>...(3)

GRAY_SCALE

</Setting>

<Setting>...</Setting>

</Scan>
<Send type=”email”>...(4)

<Setting type=”address”>...(5)

manager@xxxx.xxxx

</Setting>
<Setting>...</Setting>

</Send>

</Process>
(1)indicates a single process that is a combination of a plurality of processes, and this process is described using a process ID (here, “0001”) that uniquely identifies the process definition file 410, a process name (here, “Scan and email to section chief”), and the like.
(2)defines the generation of image data by reading an image on an original with use of the scanner.
(3)defines the generation of grayscale image data when the scanner reads the image on the original.
(4)defines the transmission of the image data by email.
(5)defines the email address (here, “manager@xxxx.xxxx”) that is the transmission destination of the image data.

Operations of MFP

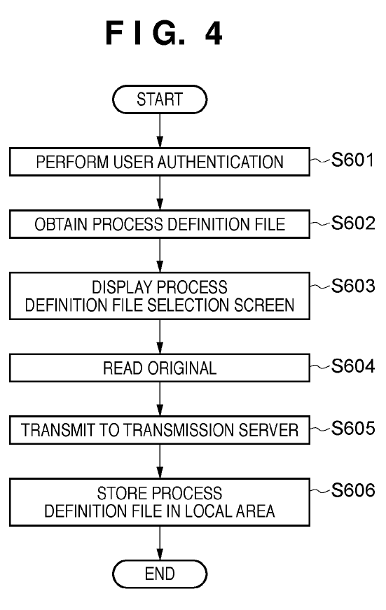

Next is a description of a series of operations in which the MFP 103 generates image data in accordance with a selected process definition file, and requests the transmission server 104 to perform processing for transmitting the image data, with reference to FIG. 4. The operations shown in this flowchart are realized by the CPU 211 of the MFP 103 executing a control program stored in the ROM 212 or the like.

Firstly, in S601 the CPU 211 performs user authentication regarding the user who is operating the MFP 103. Specifically, the MFP 103 performs user authentication by causing the operation unit 219 to display an authentication information input screen for the input of authentication information, and comparing the authentication information input via the input screen with authentication information that is held in advance. Note that the method used for user authentication may be any method, such as a method of inputting authentication information by reading an ID card, or a method of performing authentication with use of biological information.

If the user has been successfully authenticated, the procedure proceeds to S602, in which the CPU 211 requests process definition files 410 from the file management server 102 via the network I/F 218. Specifically, the CPU 211 transmits the user ID of the authenticated user to the file management server 102. Upon receiving process definition files transmitted from the file management server 102, the procedure proceeds to S603, in which the CPU 211 causes the operation unit 219 to display a selection screen 700 for allowing the user to select an arbitrary process definition file 410.

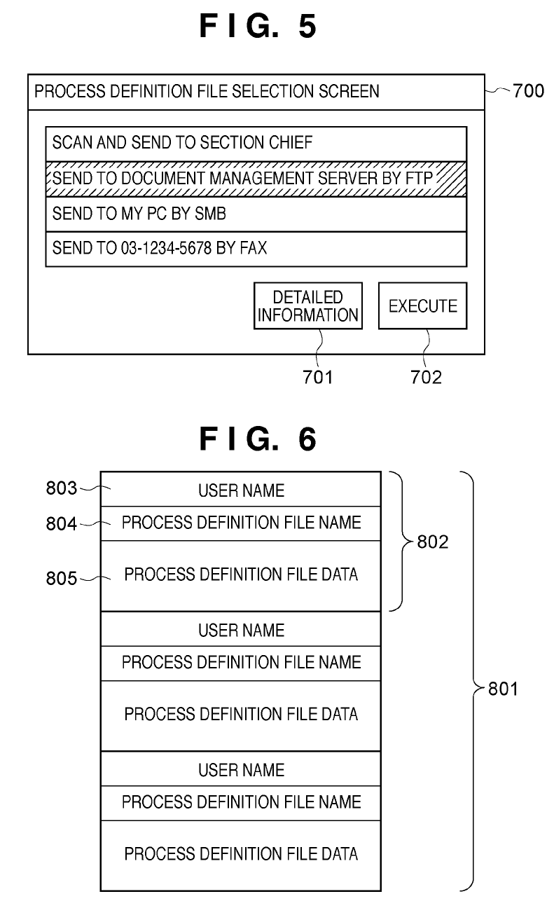

Below is a description of the selection screen 700 for selecting a process definition file 410 with reference to FIG. 5. As shown in FIG. 5, a plurality of process definition files 410 that were obtained in S603 are displayed in the selection screen 700. When the user has selected a process definition file 410, the selected process definition file 410 is displayed in an emphasized manner. In the example shown in FIG. 5, the process definition file 410 indicated by “Send to document management server by FTP” has been selected. A detailed information display button 701 and an execute button 702 are also displayed in the selection screen 700 in a selectable manner. Here, if it has been detected that the user has pressed the detailed information display button 701, the CPU 211 causes the operation unit 219 to display the detailed content of the process definition file 410 indicated by “Send to document management server by FTP”. If the user has furthermore pressed the execute button 702, the CPU 211 executes operations in accordance with the content described in the selected process definition file 410.

Let us now return to the description with reference to FIG. 4. If the execute button 702 has been pressed while “Send to document management server by FTP” is selected, in S604 the CPU 211 causes the scanner 221 to execute reading processing and generate image data in accordance with the selected process definition file 410. Subsequently, in S605 the CPU 211 associates the selected process definition file 410 and the image data (execution result) generated in S604, and transmits them to the transmission server 104, thus requesting the transmission server 104 to transmit the image data. This is performed because the process definition files defines that the transmission server 104 is the apparatus that is to execute the next process, and that the read image data is to be transmitted to another apparatus. Thereafter, in S606 the CPU 211 updates a history management file 801 that is stored in the HDD 214. The history management file 801 will be described later with reference to FIG. 6.

Note that although the history management file 801 is stored in the HDD 214 included in the MFP 103 in the present embodiment, if the MFP 103 includes another nonvolatile storage device, the history management file 801 may be stored in that nonvolatile storage device. Also, if another storage apparatus with which communication can be performed via the LAN 110 exists, the history management file 801 may be stored in that storage apparatus.

History Management File

Next is a description of the history management file 801 with reference to FIG. 6. The history management file 801 holds a usage history of processes that have been executed by the MFP 103. Note that the following description takes the example in which a transmission history is held as the usage history in the history management file 801. The history management file 801 is made up of a plurality of transmission history records 802, and a new transmission history record 802 is added to the end of the history management file 801 each time transmission is performed.

Each transmission history record 802 includes an area 803 where the name of the user who performed transmission is recorded, an area 804 where the name of the process definition that was used in transmission is recorded, and an area 805 where the data of the process definition file 410 is recorded. Note that in addition to the data areas given as examples in the present embodiment, data such as the transmission date/time may also be added to the transmission history record 802. In the above-described processing of S606, the data used in transmission is written to the areas in the transmission history record 802, and an old transmission history record 802 is deleted if necessary.

Operations Performed with Use of History Information

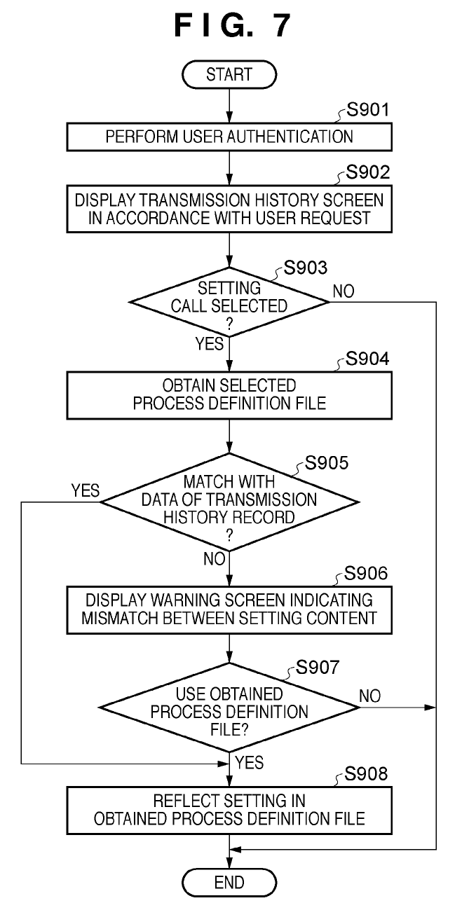

Next is a description of processing performed when using a stored transmission history to call a previously used process definition file 410 and perform re-transmission, with reference to FIG. 7. The operations shown in this flowchart are realized by the CPU 211 of the MFP 103 executing a control program stored in the ROM 212 or the like.

Firstly, in S901 the CPU 211 performs user authentication regarding the user who is operating the MFP 103. Specifically, the CPU 211 performs user authentication by causing the operation unit 219 to display an authentication information input screen for the input of authentication information, and comparing the authentication information input via the input screen with authentication information that is held in advance. Note that the method used for user authentication may be any method, such as a method of inputting authentication information by reading an ID card, or a method of performing authentication with use of biological information.

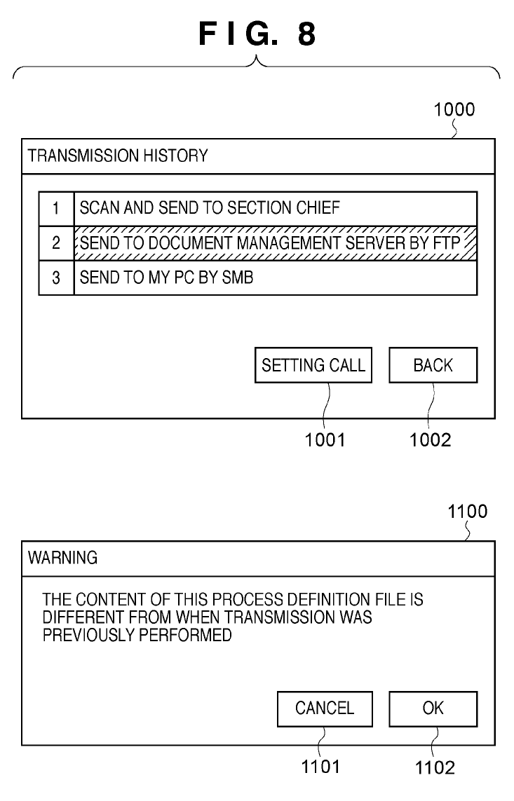

Next, upon receiving a receiving a request from the user to display a history screen 1000, in S902 the CPU 211 causes the operation unit 219 to display the history screen 1000. Next is a description of the history screen 1000 with reference to FIG. 8. In the history screen 1000, process definition files 410 that the user previously used are displayed based on the information described in the history management file 801, and a process definition file 410 is displayed in an emphasized manner upon being selected by the user. A setting call button 1001 and a back button 1002 are also displayed in the history screen 1000 in a selectable manner. In the history screen 1000 shown in FIG. 8, the process definition file 410 indicated by “Send to document management server by FTP” has been selected.

Let us now return to the description with reference to FIG. 7. In S903, the CPU 211 determines whether setting calling has been selected in the history screen 1000. Specifically, the CPU 211 determines whether the setting call button 1001 has been pressed, or the back button 1002 has been pressed. If the user has pressed the back button 1002, the CPU 211 ends processing without calling a process definition file 410 that was previously used.

On the other hand, if the setting call button 1001 has been pressed while a process definition file is selected in the history screen 1000, the procedure proceeds to S904, in which the CPU 211 obtains the corresponding process definition file 410 from the file management server 102. Specifically, the CPU 211 transmits the user ID of the authenticated user and the process definition file name to the file management server 102, and receives the process definition file 410 transmitted from the file management server 102.

Thereafter, in S905 the CPU 211 compares the process definition file data recorded in the transmission history record 802 with the content of the process definition file obtained in S904, and determines whether the two pieces of data match. If a determination has been made that the two process definition files match, the procedure proceeds to S908, in which the CPU 211 performs transmission setting in accordance with the content of the process definition file 410 that was obtained.

On the other hand, if a determination has been made that the two process definition files 410 do not match, the procedure proceeds to S906, in which the CPU 211 causes the operation unit 219 to display a warning screen 1100 shown in FIG. 8, thus informing the user that the process definition file 410 has been modified since the previous operation. As shown in FIG. 8, a cancel button 1101 and an OK button 1102 are also displayed in the warning screen 1100. Next, in S907 the CPU 211 determines whether the process definition file 410 obtained in S904 is to be used. Specifically, the CPU 211 determines whether the OK button 1102 has been pressed, or the cancel button 1101 has been pressed. If the OK button 1102 has been pressed, the procedure proceeds to S908, in which the CPU 211 performs transmission setting in accordance with the content of the process definition file 410 obtained in S904. On the other hand, if the cancel button 1101 has been pressed, the CPU 211 ends processing without using the process definition file 410 that was previously used.

Although the warning screen 1100 according to the present embodiment displays a message indicating that the process definition file 410 that was previously used and the process definition file 410 that was obtained from the file management server 102 are different, the warning screen 110 may display other content. For example, the process definition content that is different between the two process definition files 410 may be displayed as the warning screen 1100. Also, although buttons that enable selection of whether the process definition file 410 obtained in S904 is to be used are arranged in the warning screen 1100, a button enabling selection of the previous process definition file 410 that was stored at the previous time of use may be provided. Furthermore, if the previous process definition file 410 has been selected, the MFP 103 may request the file management server 102 to store that previous process definition file 410 as a new process definition file 410.

As described above, the image processing apparatus of the present embodiment is connected to another image processing apparatus and a management apparatus that manages a process definition file defining a procedure for execution of a cooperative process provided by image processing apparatuses in an image processing system. If a user has been successfully authenticated, the image processing apparatus according to the present invention displays, in a selectable manner, a previously used process definition file that corresponds to identification information used in the user authentication, and obtains the process definition file from the management apparatus in accordance with a selection made by the user. Furthermore, the image processing apparatus compares the previously used process definition file with the obtained process definition file, and determines whether they match. If the two process definition files do not match, the image processing apparatus inquires the user as to whether the obtained process definition file is to be used, and executes the next process in accordance with an instruction issued by the user. In the case of executing a process, the image processing apparatus stores the process definition file used in the process as history information. In this way, the image processing apparatus of the present embodiment stores the process definition file previously used by the user as history information, and thus a process to be executed can be selected via the history information, thereby enabling alleviation of the trouble entailed in a user operation. Moreover, if the user has selected a process definition file from the history information, the image processing apparatus of the present embodiment obtains the newest version of the process definition file from the management apparatus, and determines whether any modifications have been made from the previously used process definition file. If a modification has been made, the image processing apparatus notifies the user that a modification has been made, inquires the user as to whether the obtained process definition file is to be used, and thereafter executes a process. Accordingly, the image processing apparatus of the present embodiment enables reliable execution of a process intended by the user.

Note that in the above-described embodiment, a description is given of the example in which the processes defined in the process definition file are the execution of processing by the MFP 103 for reading an image from an original, and the execution of processing by the transmission server 104 for transmitting the read image data to a transmission destination. However, the present invention is of course not limited to this, and the processes defined in the process definition file may be processes in which, for example, the MFP 103 executes reading processing, the read image data is then transmitted to another image processing apparatus with use of the transmission server 104, and the other image processing apparatus executes print processing in accordance with the image data. Alternatively, the processes defined in the process definition file may be processes in which image data stored in the MFP 103 is transmitted to another image processing apparatus with use of the transmission server 104, and the other image processing apparatus executes print processing in accordance with the image data.

### Embodiment 2

Next is a description of Embodiment 2 of the present invention. In Embodiment 1, a configuration is described in which a process definition file 410 is stored as a transmission history when transmission is performed, and thus, when performing re-transmission with use of the transmission history, the user is notified if the process definition file differs from the previously used process definition file. In contrast, in the present embodiment, a description is given of the example in which a process definition file hash function value is stored as a history management file. Note that only differences from the above-described embodiment are described below. Accordingly, configurations and control not described specifically are assumed to be the same as in the above-described embodiment.

Operations of MFP

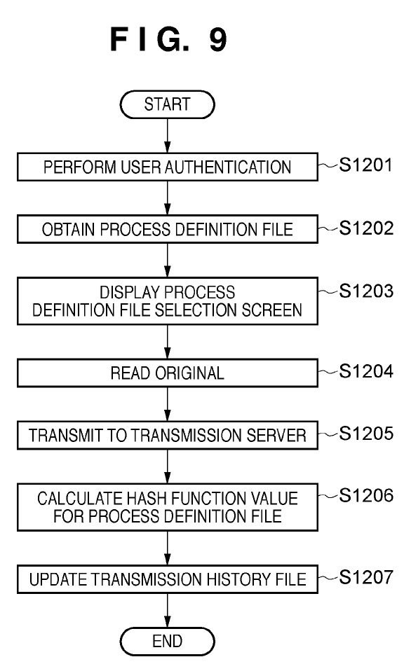

First is a description of a series of operations in which the MFP 103 generates image data in accordance with a selected process definition file 410, and requests the transmission server 104 to perform processing for transmitting the image data, with reference to FIG. 9. The operations shown in this flowchart are realized by the CPU 211 of the MFP 103 executing a control program stored in the ROM 212 or the like.

Firstly, in S1201 the CPU 211 performs user authentication regarding the user who is operating the MFP 103. Specifically, the CPU 211 performs user authentication by causing the operation unit 219 to display an authentication information input screen for the input of authentication information, and comparing the authentication information input via the input screen with authentication information that is held in advance. Note that the method used for user authentication may be any method, such as a method of inputting authentication information by reading an ID card, or a method of performing authentication with use of biological information.

If the user has been successfully authenticated, the procedure proceeds to S1202, in which the CPU 211 requests process definition files 410 from the file management server 102 via the network I/F 218. Specifically, the CPU 211 transmits the user ID of the authenticated user to the file management server 102. Upon receiving process definition files transmitted from the file management server 102, the procedure proceeds to S1203, in which the CPU 211 causes the operation unit 219 to display the selection screen 700 for allowing the user to select an arbitrary process definition file 410.

If the execute button 702 has been pressed in the selection screen 700, the procedure proceeds to S1204, in which CPU 211 causes the scanner 221 to execute reading processing and generate image data in accordance with the selected process definition file 410. Subsequently, in S1205 the CPU 211 associates the selected process definition file 410 and the image data generated in S1204, and transmits them to the transmission server 104, thus requesting the transmission server 104 to transmit the image data.

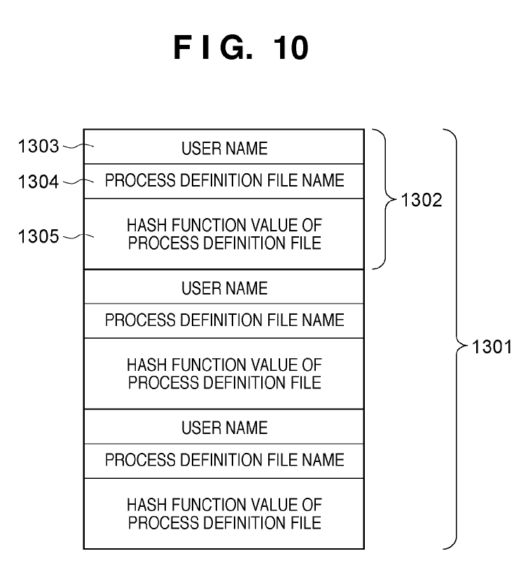

Thereafter, in S1206 the CPU 211 calculates a hash function value for the process definition file 410 used in S1203. The hash function used here may be a generally used hash function such as MD5 or SHA-1, or another appropriate function. In the case of MD5 or SHA-1, the function value obtained as the calculation result is around 100 bytes long, and in most cases is smaller than the size of the process definition file 410. Next, in S1207, the CPU 211 updates a history management file 1301 that is stored in the HDD 214. The history management file 1301 will be described later with reference to FIG. 10.

Note that although the history management file 1301 is stored in the HDD 214 included in the MFP 103 in the present embodiment, if the MFP 103 includes another nonvolatile storage device, the history management file 1301 may be stored in that nonvolatile storage device. Also, if another storage apparatus with which communication can be performed via the LAN 110 exists, the history management file 1301 may be stored in that storage apparatus.

History Management File

Next is a description of the history management file 1301 with reference to FIG. 10. The history management file 1301 holds a history of processes that have been executed by the MFP 103. Note that the following description takes the example in which a transmission history is held as the usage history in the history management file 1301. The history management file 1301 is made up of a plurality of transmission history records 1302, and a new transmission history record 1302 is added to the end of the history management file 1301 each time transmission is performed.

Each transmission history record 1302 includes an area 1303 where the name of the user who performed transmission is recorded, an area 1304 where the name of the process definition that was used in transmission is recorded, and an area 1305 where the hash function value of the process definition file is recorded. Note that in addition to the data areas given as examples in the present embodiment, data such as the transmission date/time may also be added to the transmission history record 1302. In the above-described processing of S1206, the CPU 211 performs processing for writing the data used in transmission to the areas in the transmission history record 1302, and deleting an old transmission history record 1302 if necessary.

Operations Performed with Use of History Information

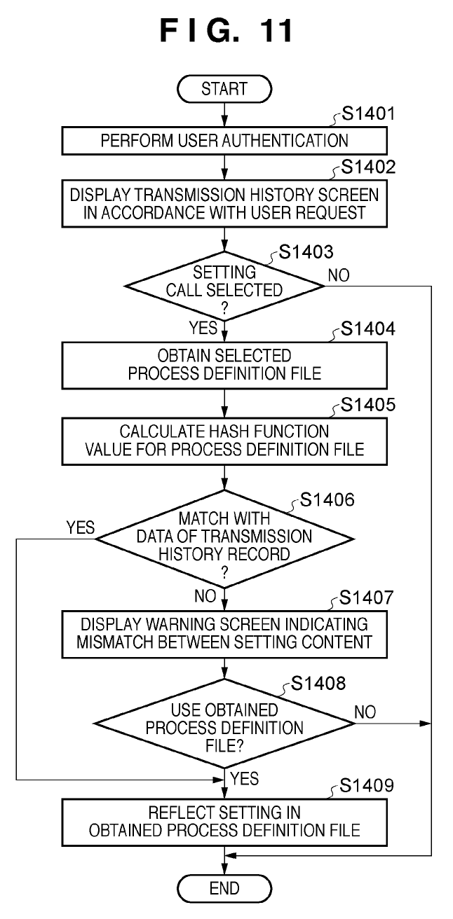

Next is a description of processing performed when using a stored transmission history to call a previously used process definition file 410 and perform re-transmission, with reference to FIG. 11. The operations shown in this flowchart are realized by the CPU 211 of the MFP 103 executing a control program stored in the ROM 212 or the like. Note that a description of processing that is the same as that in the flowchart of FIG. 7 has been omitted. Specifically, the processing of S1401 to S1404 and S1406 to S1409 is the same as that of S901 to S904 and S905 to S908, and therefore a description thereof has been omitted.

If a process definition file 410 has been received in S1404, the procedure proceeds to S1405, in which the CPU 211 calculates a hash function value for the process definition file 410 that was obtained. It is necessary for the hash function used here to be the same as the hash function used in S1206. Thereafter, in S1406 the CPU 211 compares the hash function value of the process definition file 410 recorded in the transmission history record 1302 with the hash function value of the process definition file calculated in S1405, and determines whether the two hash function values match. Based on the properties of the hash function, it is possible to determine that the content of the two process definition files 410 is the same if the two hash function values match in S1406.

As described above, the image processing apparatus according to the present embodiment differs from that of Embodiment 1 with respect to storing a hash value of a process definition file as history information. Accordingly, in addition to the effects of Embodiment 1, the image processing apparatus of the present embodiment enables reduction in the file size of the history information.

### Embodiment 3

Next is a description of Embodiment 3 of the present invention. In Embodiment 2, a configuration is described in which a hash value of a process definition file 410 is stored as a transmission history when transmission is performed, thus enabling prevention of transmission that is not intended by the user. In contrast, in the present embodiment, a description is given of the example in which a process definition file 410 is divided into a plurality of portions, and a hash function value for each portion is stored in the history management file.

Accordingly, in the present embodiment, in the processing of S1206 described in Embodiment 2, a hash function value is calculated for each portion of the process definition file 410. It is assumed here that the process definition file 410 described as a specific example of a process definition file in Embodiment 1 is used, and hash function values are calculated for the content of (2) and (4). Note that only differences from the above-described embodiments are described below. Accordingly, configurations and control not described specifically are assumed to be the same as in the above-described embodiments.

History Management File

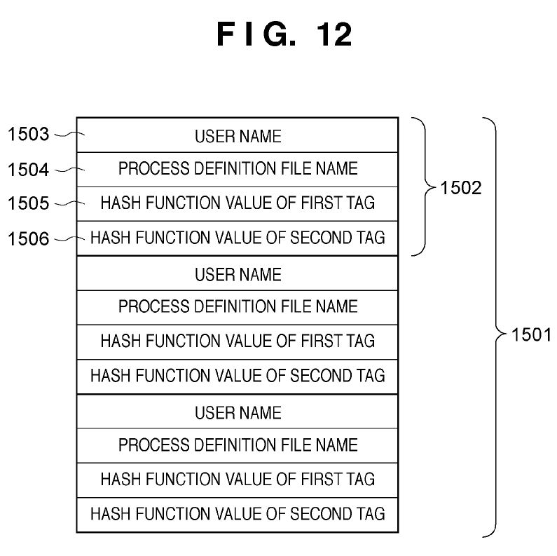

Next is a description of a history management file 1501 of Embodiment 3 with reference to FIG. 12. The history management file 1501 holds a history of processes that have been executed by the MFP 103. Note that the following description takes the example in which a transmission history is held as the usage history in the history management file 1501. The history management file 1501 is made up of a plurality of transmission history records 1502, and a new transmission history record 1502 is added to the end of the history management file 1501 each time transmission is performed.

Each transmission history record 1502 includes an area 1503 where the name of the user who performed transmission is recorded, an area 1504 where the name of the process definition that was used in transmission is recorded, and areas 1505 and 1506 where the hash function values of the portions (here, (2) and (4)) are recorded. Hereinafter, the area for (2) is called the “first tag”, and the area for (4) is called the “second tag”. The hash values calculated in S1206 are stored in the areas 1505 and 1506 respectively. Although a description is given here taking the example of the transmission history record having the two areas 1505 and 1506 as the hash function values for the portions, the present invention is of course not limited to this number of areas, and an arbitrary number of areas may be provided.

Operations Performed with Use of History Information

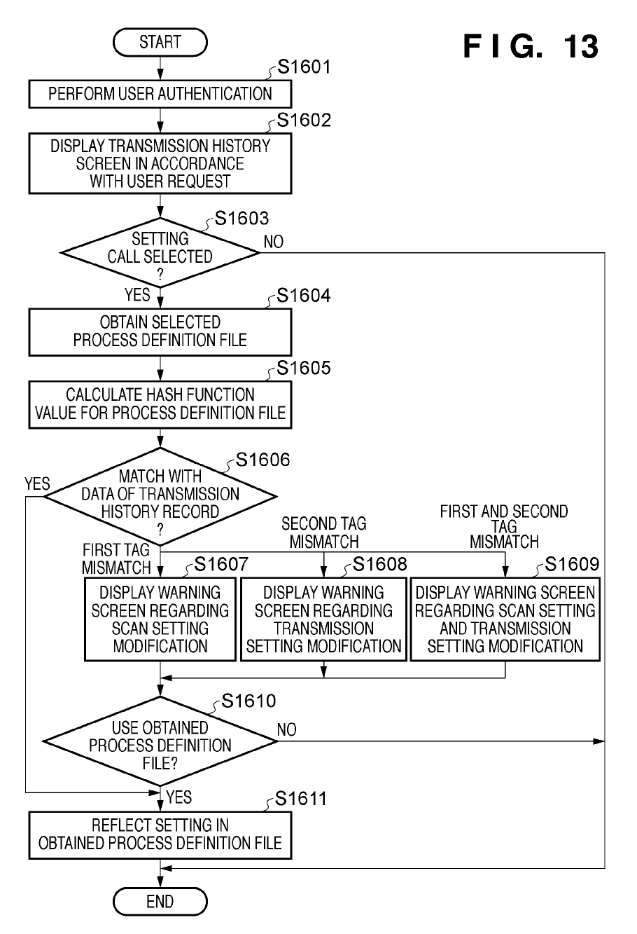

Next is a description of processing performed when using a stored transmission history to call a previously used process definition file 410 and perform re-transmission, with reference to FIG. 13. The operations shown in this flowchart are realized by the CPU 211 of the MFP 103 executing a control program stored in the ROM 212 or the like. Note that a description of processing that is the same as that in the flowchart of FIG. 11 has been omitted. Specifically, the processing of S1601 to S1605 and S1610 and S1611 is the same as that of S1401 to S1405 and S1408 and S1409, and therefore a description thereof has been omitted.

In S1605, the CPU 211 calculates hash function values for the content of the first tag and the second tag in the process definition file that was obtained in S1604. It is necessary for the hash function used here to be the same as the hash function used in S1206. Thereafter, in S1606, the MFP 103 compares the hash function values of the first tag and the second tag recorded in the transmission history record 1502, with the hash function values of the first tag and the second tag in the process definition file 410 that were calculated in S1605, and determines whether they match. Here, the procedure proceeds to S1611 if the hash function values of both of the tags match, the procedure proceeds to S1607 if the first tags do not match, the procedure proceeds to S1608 if the second tags do not match, and the procedure proceeds to S1609 if both the first tags and the second tags do not match.

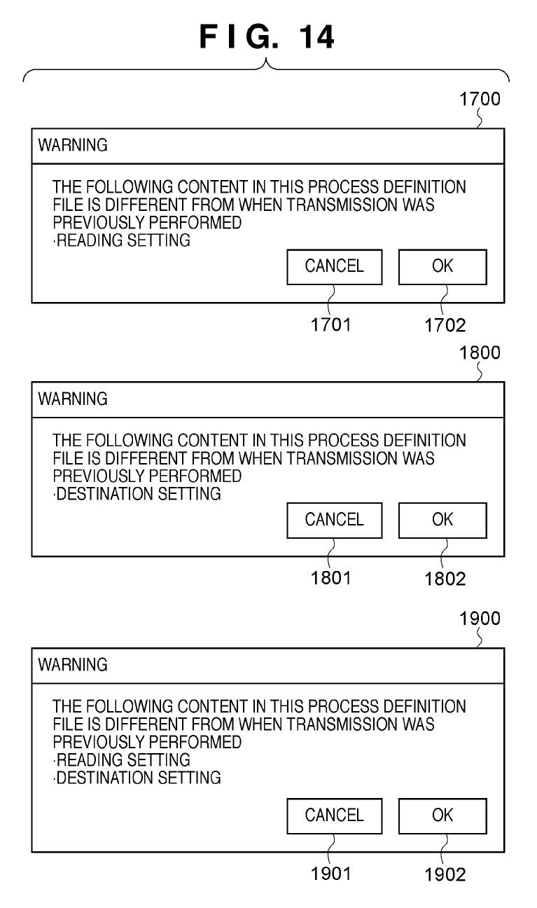

In S1607, since the scanner reading settings, which are described in the first tag, are different, the CPU 211 causes the operation unit 219 to display a warning screen 1700, which is shown in FIG. 14, and then proceeds to S1610. As shown in FIG. 14, a cancel button 1701 and an OK button 1702 are displayed in the warning screen 1700.

In S1608, since the image data transmission settings, which are described in the second tag, are different, the CPU 211 causes the operation unit 219 to display a warning screen 1800, which is shown in FIG. 14, and then proceeds to S1610. As shown in FIG. 14, a cancel button 1801 and an OK button 1802 are displayed in the warning screen 1800.

In S1609, since the scanner reading settings and the image data transmission settings, which are described in the first tag and the second tag, are different, the CPU 211 causes the operation unit 219 to display a warning screen 1900, which is shown in FIG. 14, and then proceeds to S1610. As shown in FIG. 14, a cancel button 1901 and an OK button 1902 are displayed in the warning screen 1900.

As described above, the image processing apparatus according to the present embodiment stores a hash value for each process defined in a process definition file as history information. Accordingly, in addition to the effects of Embodiment 2, if a process definition file has been modified from the previously used process definition file, the image processing apparatus of the present embodiment can inform the user about which processes have been modified. Also, similarly to Embodiment 1, the content of processes in the process definition file may be stored in the present embodiment, instead of using hash values.

### Embodiment 4

Next is a description of Embodiment 4 of the present invention. In Embodiment 1, a configuration is described in which a process definition file 410 is stored as a transmission history when transmission is performed, and thus, when performing re-transmission with use of the transmission history, the user is notified if the process definition file differs from the previously used process definition file. In contrast, in the present embodiment, a description is given of the example in which only a portion of a process definition file 410 is stored in the history management file. Note that only differences from the above-described embodiments are described below. Accordingly, configurations and control not described specifically are assumed to be the same as in the above-described embodiments.

Storage Setting

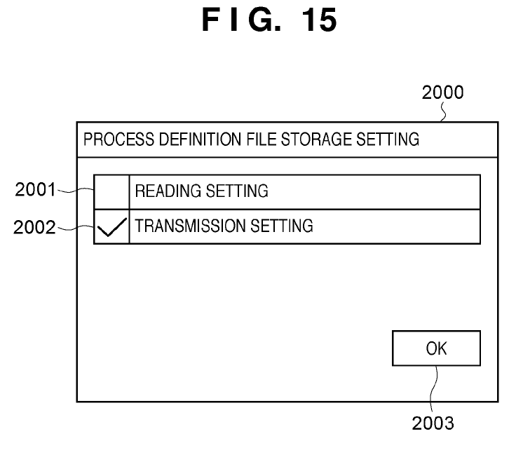

Below is a description of a storage setting screen 2000 for a process definition file 410 with reference to FIG. 15. The storage setting screen 2000 is used for setting, in advance, process definition file content that is to be stored in the process definition file data area 805 shown in FIG. 6. Also, a reading setting checkbox 2001, a transmission setting checkbox 2002, and an OK button 2003 are displayed in the storage setting screen 2000 in a selectable manner.

If the reading setting checkbox 2001 has been selected, in the processing of S606 shown in FIG. 4, the CPU 211 performs setting such that the content of the first tag indicating the reading setting in the process definition file 410 is to be stored in the area 805. If the transmission setting checkbox 2002 has been selected, in the processing of S606, the CPU 211 performs setting such that the content of the second tag indicating the transmission setting in the process definition file 410 is to be stored in the area 805. If the OK button 2003 has been pressed by the user, the CPU 211 stores the conditions of the checkboxes 2001 and 2002 in the HDD 214. In the case of the setting shown in FIG. 15, only the checkbox 2002 has been selected, and therefore only the content of the second tag is stored in the area 805.

Operations Performed with Use of History Information

Next is a description of processing performed when using a transmission history stored as described above to call a previously used process definition file 410 and perform re-transmission. When performing the processing of S905 shown in FIG. 7, the conditions of the checkboxes 2001 and 2002 stored in the HDD 214 are checked. With reference to these conditions, the corresponding portion of the process definition file 410 that was obtained in S904 and the content of the process definition file 410 are compared. In the case of the setting shown in FIG. 15, the content of the second tag is stored in the area 805, and therefore the CPU 211 compares the content of the second tag in the process definition file obtained in S904 with the content of the area 805. If the content of the second tag has been modified, the operation unit 219 is caused to display the warning screen 1100 shown in FIG. 8.

As described above, in the case where history information is stored for each process as in Embodiment 3, the image processing apparatus according to the present embodiment designates, in advance, a process in the process definition file that is to be stored as history information. Accordingly, the image processing apparatus of the present embodiment can reduce the file size of the history information, as well as suitably notify content that has been modified in a process definition file desired by the user.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-265534 filed on Nov. 20, 2009, which is hereby incorporated by reference herein in its entirety.

What is claimed is:

1. An image processing apparatus that can be connected to another image processing apparatus and a management apparatus that manages a process definition file in an updatable manner, the process definition file defining a procedure for execution of a cooperative process provided by a plurality of image processing apparatuses, the image processing apparatus comprising:
an authentication unit that performs user authentication;
a display unit that, in a case where a user has been successfully authenticated, displays a selection screen in which the process definition file is displayed so as to be selectable from history information that indicates a usage history of the process definition file that is in association with identification information of the authenticated user;
a selection unit that selects the process definition file in accordance with information that has been input by the user via an operation unit;
an obtaining unit that obtains the selected process definition file from the management apparatus;
a comparison unit that compares the obtained process definition file with the process definition file pertaining to a previous usage; and
an inquiry unit that, in a case where a result of the comparison performed by the comparison unit is that content of a defined process is different between the process definition files, inquires the user as to whether the process definition file that is different from the process definition file pertaining to the previous usage is to be used.

2. The image processing apparatus according to claim 1, comprising:
an execution unit that, in a case where a result of the comparison performed by the comparison unit is that content of a defined process is not different between the process definition files, or that content of a defined process is different between the process definition files and furthermore an instruction to use the process definition file that is different has been acquired in response to the inquiry performed by the inquiry unit, executes a process in accordance with the process definition file obtained from the management apparatus;
a transmission unit that transmits an execution result from the execution unit and the process definition file that was used to the other image processing apparatus that executes the next process defined in the process definition file; and
a storage unit that stores the process definition file that was used, as the history information.

3. The image processing apparatus according to claim 2,
wherein the storage unit stores, as the history information, the identification information of the user, identification information of the process definition file, and content of the process definition file.

4. The image processing apparatus according to claim 2,
wherein the storage unit stores, as the history information, the identification information of the user, identification information of the process definition file, and a hash value of the process definition file, and
the comparison unit compares the hash value of the obtained process definition file with the hash value of the process definition file pertaining to the previous usage.

5. The image processing apparatus according to claim 2,
wherein the storage unit stores, as the history information, the identification information of the user, identification information of the process definition file, and a hash value of each process defined in the process definition file, and
the comparison unit compares the hash values of the processes defined in the obtained process definition file with the hash values of the processes defined in the process definition file pertaining to the previous usage.

6. The image processing apparatus according to claim 2, comprising:
a unit that selects content to be stored by the storage unit,
wherein the storage unit stores, as the history information, the identification information of the user, identification information of the process definition file, and content selected as the storage content among content defined in the process definition file, and
the comparison unit compares the content selected as the storage content among content defined in the obtained process definition file with the content selected as the storage content among content defined in the process definition file pertaining to the previous usage.

7. The image processing apparatus according to claim 2,
wherein the execution unit executes reading processing for reading an image from an original,
the transmission unit transmits image data read from the original as a result of the execution of the reading processing by the execution unit, and
the other image processing apparatus transmits the image data to a transmission destination defined in the process definition file.

8. An image processing system comprising a plurality of image processing apparatuses and a management apparatus that manages a process definition file in an updatable manner, the process definition file defining a procedure for execution of a cooperative process provided by the plurality of image processing apparatuses, each of the image processing apparatuses comprising:
an authentication unit that performs user authentication;
a display unit that, in a case where a user has been successfully authenticated, displays a selection screen in which the process definition file is displayed so as to be selectable from history information that indicates a usage history of the process definition file that is in association with identification information of the authenticated user;
a selection unit that selects the process definition file in accordance with information that has been input by the user via an operation unit;
an obtaining unit that obtains the selected process definition file from the management apparatus;
a comparison unit that compares the obtained process definition file with the process definition file pertaining to a previous usage; and
an inquiry unit that, in a case where a result of the comparison performed by the comparison unit is that content of a defined process is different between the process definition files, inquires the user as to whether the process definition file that is different from the process definition file pertaining to the previous usage is to be used.

9. A control method for an image processing apparatus that can be connected to another image processing apparatus and a management apparatus that manages a process definition file in an updatable manner, the process definition file defining a procedure for execution of a cooperative process provided by a plurality of image processing apparatuses, the control method comprising:
performing user authentication by an authentication unit;
in a case where a user has been successfully authenticated, displaying, by a display unit, a selection screen in which the process definition file is displayed so as to be selectable from history information that indicates a usage history of the process definition file that is in association with identification information of the authenticated user;
selecting, by a selection unit, the process definition file in accordance with information that has been input by the user via an operation unit;
obtaining, by an obtaining unit, the selected process definition file from the management apparatus;
comparing, by a comparison unit, the obtained process definition file with the process definition file pertaining to a previous usage; and
in a case where a result of the comparison performed by the comparison unit is that content of a defined process is different between the process definition files, inquiring, by an inquiry unit, the user as to whether the process definition file that is different from the process definition file pertaining to the previous usage is to be used.

10. A control method for an image processing system comprising a plurality of image processing apparatuses and a management apparatus that manages a process definition file in an updatable manner, the process definition file defining a procedure for execution of a cooperative process provided by the plurality of image processing apparatuses, the control method comprising:
in each of the image processing apparatuses,
performing user authentication by an authentication unit;
in a case where a user has been successfully authenticated, displaying, by a display unit, a selection screen in which the process definition file is displayed so as to be selectable from history information that indicates a usage history of the process definition file that is in association with identification information of the authenticated user;
selecting, by a selection unit, the process definition file in accordance with information that has been input by the user via an operation unit;
obtaining, by an obtaining unit, the selected process definition file from the management apparatus;
comparing, by a comparison unit, the obtained process definition file with the process definition file pertaining to a previous usage; and
in a case where a result of the comparison performed by the comparison unit is that content of a defined process is different between the process definition files, inquiring, by an inquiry unit, the user as to whether the process definition file that is different from the process definition file pertaining to the previous usage is to be used.

11. A computer-readable storage medium storing a computer program for causing a computer to execute the control method for an image processing apparatus according to claim 9.

12. A computer-readable storage medium storing a computer program for causing a computer to execute the control method for an image processing system according to claim 10.
